(19) United States
(12) Patent Application Publication
(10) Pub. No.: US 2008/0012805 A1
(43) Pub. Date: Jan. 17, 2008

(54) System and method for predictive pulse modulation in display applications

(75) Inventors: Walter M. Duncan, Dallas, TX (US); Fred Jay Reuter, Plano, TX (US); Paul L. Rancuret, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/486,517

(22) Filed: Jul. 13, 2006

(51) Int. Cl. G09G 3/34

(52) U.S. Cl. 345/84

(57) ABSTRACT

System and method for using predictive pulse modulation in display applications. A preferred embodiment comprises sampling a light output of a light source, computing a usage history of the light source, and processing the samples of the light output in combination with the usage history to characterize the light source. The characterization of the light source can be used in conjunction with a desired light output to determine a current pulse waveform to provide to the light source to have the light source produce the desired light output. The characterization of the light source can occur during normal use of the display system or during manufacture or setup and configuration of the display system.

### TECHNICAL FIELD

The present invention relates generally to a system and a method for display systems, and more particularly to a system and method for using predictive pulse modulation in display applications.

### BACKGROUND

In one embodiment of a display system, such as one used for television or digital projector applications, a spatial light modulator is illuminated with a light source or light sources containing component red (R), green (G), and blue (B) (and potentially other) colors. Light from the light source or light sources is then reflected off or transmitted through a spatial light modulator and is imaged to a screen or other surface for viewing. When using light emitting diodes or lasers in such displays, each source produces light in a relatively narrow region of the visible spectrum. Hence at least three laser or light emitting diode sources representing red, green and blue regions of the visible spectrum typically are used to produce a color display. Because the response of the human eye is relatively slow to respond to light impulses, a single spatial light modulator can be illuminated with a rapid sequence (sub 10 milliseconds) of three or more different colors to present a full color display. Alternatively, the three color sources, such as R, G, and B, can illuminate three separate spatial light modulators that can then be combined and viewed as a full color image at a screen. High brightness electric arc lamps are widely used as light sources for display systems. However, due to disadvantages such as slow turn on times, short useful life spans, high power consumption, need for color separation filtering, and so forth, electric arc lamp sources are being replaced by solid-state light sources, such as laser diodes and light emitting diodes.

With reference now to FIGS. 1a and 1b, there are shown diagrams illustrating common architectures of solid-state laser light sources for producing visible radiation. The diagram shown in FIG. 1a illustrates laser diode 100 with a near infrared (NIR) emitter that is frequency doubled with a second harmonic generator (SHG) to produce visible radiation. The diagram shown in FIG. 1billustrates a simple direct emission laser diode 102 that is capable of emitting in the visible portion of the electromagnetic spectrum.

The use of solid-state light sources to illuminate spatial light modulators in a micro-display system has advantages that include low power consumption, rapid switching times that potentially permit a reduction in the minimum amount of displayable light or minimum bit size, long useful light source life, short power on time, elimination of color separation filters, as well as other advantages compared to arc lamps. Furthermore, solid-state light sources can be created to provide narrow-band light at a variety of frequency ranges, therefore, a combination light source comprising a plurality of solid-state light sources can be used, wherein the solid-state light sources can be selected to provide light in the colors desired for a given display system.

With reference now to FIG. 2, there is shown an exemplary projection display system 200. The projection display system 200 includes an array of light modulators, such as a digital micromirror device (DMD) 205, which is controlled by a sequence controller 210. The sequence controller 210 can be responsible for operations such as loading image data into the DMD 205, synchronizing the operation of the DMD 205, controlling the operation of a light source 215, and so forth. The light source 215, as shown in FIG. 2, includes individual solid-state light sources. The solid-state light sources used in the light source 215 are laser diodes, although light emitting diodes can also be used. The individual solid-state light sources provide narrow-band light at the required colors for the display system 200, such as a red laser 220, a green laser 225, and a blue laser 230. The projection display system 200 shown in FIG. 2 is an RGB display system; multiprimary display systems are also available. Light from the individual solid-state light sources, such as the red laser 220, the green laser 225, and the blue laser 230, can be optically combined by optical multiplexers 222 and 227. A mirror 235 can direct the multiplexed light from the light source 215 onto the DMD 205. The DMD 205 modulates the light and reflects the image onto a display plane 240.

One disadvantage of the prior art is that the light produced by a solid-state light source may not instantaneously emit with the application of a drive current. A time lag may be present between the application of the drive current and the emission of the radiation. This is further compounded by the fact that the lag can vary depending on the temperature of one or more sub-components of the solid-state light source as well as the magnitude of the voltage and/or current driven into the solid-state light source. Therefore, there can be a degree of uncertainty in the light produced by the solid-state light source. With reference now to FIG. 3, there is shown a diagram illustrating an exemplary current pulse waveform 305 used to power a solid-state light source and a light output waveform 310 of the solid-state light source in response to the current pulse waveform. A comparison of the two waveforms 305 and 310 shows that the solid-state light source does not start to emit radiation synchronously with the beginning of the pulsed drive current waveform 305. Instead, there is an appreciable time lag before the solid-state light source begins to emit radiation. Furthermore, the emissions of the solid-state light source do not immediately reach a maximum, but gradually rises to a steady state value.

Another disadvantage of the prior art is that the light produced by the solid-state light source may not be linear over the time that the drive current is being applied. For example, the light may slowly rise with the initial application of the drive current to reach a maximum value and then decay as the drive current is maintained. This can further lead to uncertainty in the light produced by the solid-state light source.

### SUMMARY OF THE INVENTION

These and other problems are generally solved or circumvented, and technical advantages are generally achieved, by preferred embodiments of the present invention which provide a system and method for using predictive pulse modulation in display applications.

In accordance with a preferred embodiment of the present invention, a method for characterizing a light source is provided. The method includes sampling a light output of the light source and computing a usage history of the light source. The method also includes processing the samples of the light output in combination with the usage history to characterize the light source.

In accordance with another preferred embodiment of the present invention, a method for driving a light source is provided. The method includes receiving a set of specifications for a desired light output and using characterization information for the light source to derive a current waveform. The method also includes providing the current waveform to the light source.

In accordance with another preferred embodiment of the present invention, a display system is provided. The display system includes a solid-state light source, an array of light modulators optically coupled to the solid-state light source, a sequence controller coupled to the array of light modulators, a light-to-electricity converter optically coupled between the solid-state light source and the array of light modulators, and a processor coupled between the light-to-electricity converter and the solid-state light source. The solid-state light source emits radiation in response to a current waveform provided to it, while the array of light modulators modulates light from the solid-state light source based upon image data to produce images on a display plane and the sequence controller issues commands to control the operation of the array of light modulators. The light-to-electricity converter periodically samples the light produced by the solid-state light source and converts the samples into electrical signals that can be used by the processor to create a characterization of the solid-state light source.

An advantage of a preferred embodiment of the present invention is that the output of the solid-state light source can be adjusted based upon the recent optical power output and/or usage history of the solid-state light source. This method can allow for the optimization of the output of the solid-state light source to meet light intensity requirements in display applications.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1bare diagrams of common architectures of solid-state light sources for producing visible laser radiation;

FIG. 2 is a diagram of a projection display system;

FIG. 3 is a diagram of a pulsed drive current waveform and a light output waveform;

FIGS. 4a and 4b are diagrams showing the effects of temperature and current on the wavelength of emitted radiation from a typical infrared (IR) laser diode;

FIGS. 5a and 5b are diagrams of sequences of events in the characterization of a solid-state light source, according to a preferred embodiment of the present invention;

FIGS. 6a and 6b are diagrams of an exemplary current pulse waveform and sampled light output of a solid-state light source, according to a preferred embodiment of the present invention;

FIG. 7 is a diagram of a sequence of events in the use of the characterization and usage history of a solid-state light source to provide a current pulse waveform, according to a preferred embodiment of the present invention; and

FIG. 8 is a diagram of a projection display system, according to a preferred embodiment of the present invention.

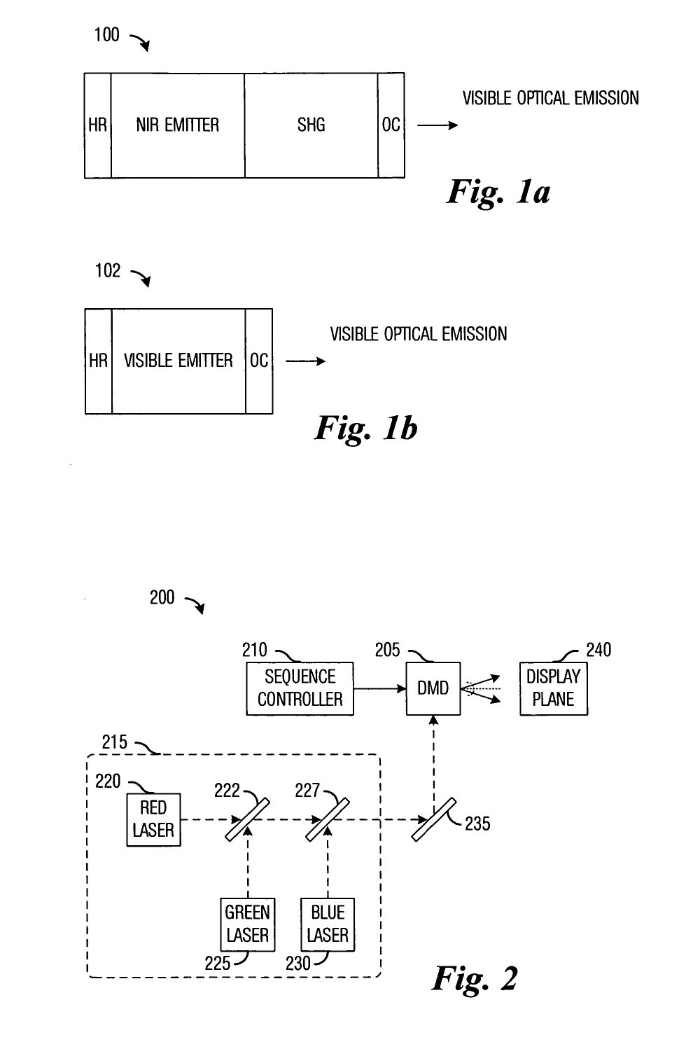

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a solid-state light source utilizing laser diodes and/or light emitting diodes being used as a light source for a display system, wherein the spatial light modulator is a digital micromirror device (DMD). The invention may also be applied, however, to other display systems, such as display systems utilizing deformable mirrors, transmissive liquid crystals, reflective liquid crystals, liquid crystal on silicon, and so forth. Furthermore, the present invention can also be applied to applications wherein there is a desire to have a predictable light source, when solid-state sources are used.

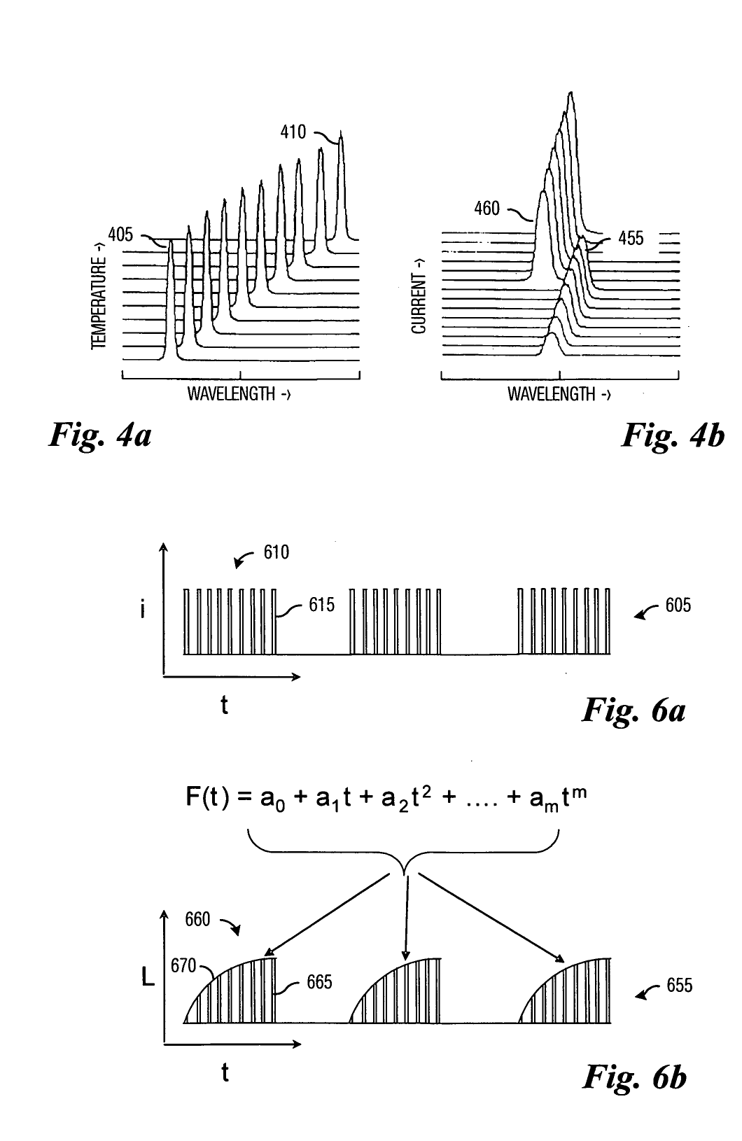

With reference now to FIGS. 4a and 4b, there are shown diagrams illustrating the effect of temperature and current, respectively, on the wavelength of emitted radiation from a typical laser IR diode. The diagram shown in FIG. 4a illustrates the effect of thermal tuning on the wavelength of the emitted radiation from a typical distributed feedback laser. For example, at eight (8) degrees Celsius, the wavelength of the emitted radiation can be approximately 1082.4 nm (shown as curve 405), while at 26 degrees Celsius, the wavelength of the emitted radiation can be approximately 1083.8 nm (shown as curve 410).

The diagram shown in FIG. 4b illustrates the effect of current tuning on the wavelength of the emitted radiation from a typical distributed feedback laser. Interestingly, the change in the wavelength of the emitted radiation as a function of the current can be periodic in nature. As the current increases, the wavelength also increases, with a net wavelength change of about 1.2 Angstroms. However, as the current further increases, the wavelength of the emitted radiation drops back down and then begins to increase once again as the current continues to increase. This is seen by comparing curve 455 and curve 460. Although the wavelength may be periodic with respect to the current, the magnitude of the emitted radiation can increase as a function of the current, until a steady state value is achieved.

The change in the wavelength of the emitted radiation can have a consistent behavior that varies with changing temperature and current. This behavior can be used to predict the wavelength of emitted radiation as a function of the temperature and the current. In addition to predicting the wavelength, it can also be possible to predict the magnitude or intensity of the emitted radiation. Utilizing the ability to predict the wavelength and the magnitude, it can be possible to adjust the current driving a single laser diode or light emitting diode or a plurality of light generating diodes to ensure that the diodes (both laser and light) are providing the desired light intensity to the system and screen.

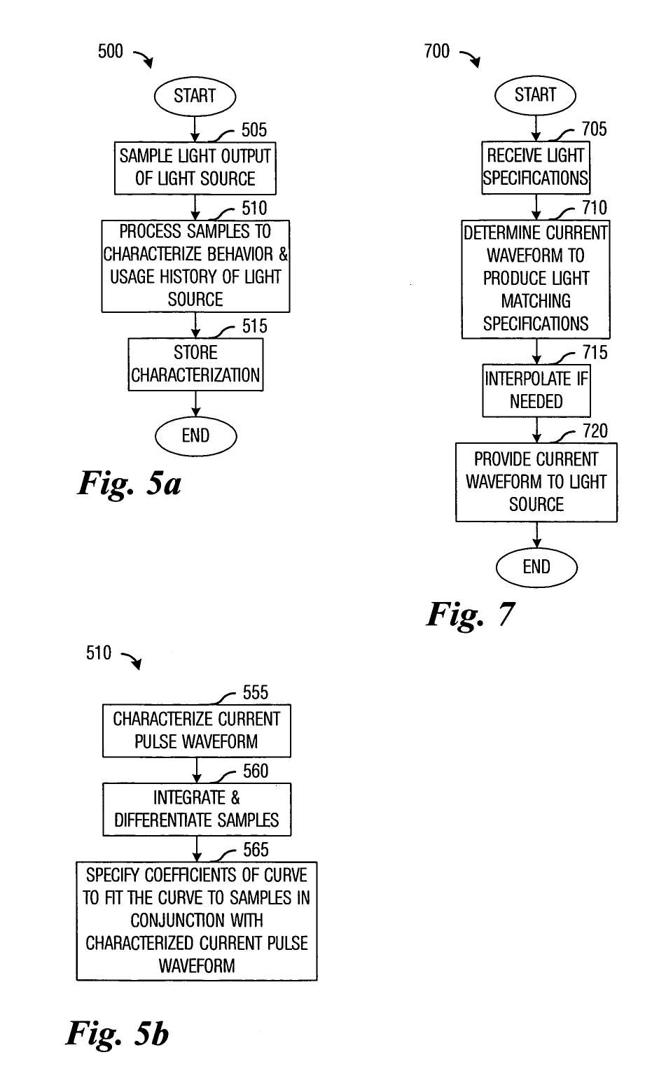

With reference now to FIG. 5a, there is shown a diagram illustrating a high-level view of a sequence of events 500 in the characterization of the behavior of a solid-state light source using sampled emitted radiation, according to a preferred embodiment of the present invention. The sequence of events 500 can be used to characterize the solid-state light source during normal operation. For example, as the solid-state light source is providing light to illuminate an array of light modulators, samples of the light produced by the solid-state light source can be taken to characterize the solid-state light source. In an alternate preferred embodiment of the present invention, the characterization of the solid-state light source can occur during an initialization process, such as during testing after manufacture or during configuration and set up of the projection display system.

The characterization of the solid-state light source can begin with the sampling of the light output produced by the solid-state light source (block 505). According to a preferred embodiment of the present invention, the sampling of the light output can be achieved through the use of a light tap inserted into a light path of the solid-state light source. The light tap can divert a small amount of light produced by the solid-state light source, which can then be detected by a photo diode, converting the light from the light tap into an electrical signal that is proportional to the light intensity.

A number of devices could be used for the conversion of the light, such as a photo detector, a photodiode, photomultiplier tube, or any of the myriad of devices referred to as bolometers, pyrometers, photoconductors or photovoltaic devices. Furthermore, any device that senses optical power or energy and converts the power or energy to an electrical signal, capacitance, voltage, current or electrical induction, could be used.

According to a preferred embodiment of the present invention, light scattered, reflected, emitted, transmitted, refracted, diffracted, or combinations thereof, can be collected and converted into an electrical signal that is related to the light intensity or other properties from any one or all of the light sources. Furthermore, elements such as beam splitters, diffractive optical elements, mirrors, grating, beam shaping optics, and so forth, are often used in projection display systems. Light that is scattered, reflected, emitted, transmitted, refracted, diffracted, or combinations thereof, off any of these elements and others placed in the system with or without the specific intention and primary function of tapping light and monitoring can be used. The light taps can also be built into the light sources themselves or can result from unintentional scattering, reflection, emission, or transmission effects from any of the system components.

Electrical signals representing the samples of the light output of the solid-state light source can then be processed to provide a characterization of the behavior of the solid-state light source (block 510). Additionally, using information such as the magnitude, frequency, duty cycle, and so forth, of the current provided to the solid-state light source, a usage history of the solid-state light source can also be determined. For example, if it is known that the current pulse waveform driving the solid-state light source has a 330 MHz frequency with a 33% duty cycle and the current has been applied for about 300 micro-seconds and the samples of the light output indicate that the solid-state light source is emitting no light, then it can be determined that there is a lag time of at least 300 micro-seconds with the solid-state light source when it is driven with the current pulse waveform. The processing of the electrical signals can include integrating and differentiating the electrical signals to determine an average power for a given unit time and a differential power for a differential time.

Once the behavior of the solid-state light source and the usage history has been determined, the information can be stored for later use (block 515). The information can be stored in a memory that can be accessed when there is a need to provide a light with a specified set of characteristics. From the specified set of characteristics, it can be possible to retrieve a current waveform to be provided to the solid-state light source to have the solid-state light source produce the light. As discussed previously, the characterization of the solid-state light source and the usage history can be determined continuously during the use of the solid-state light source, therefore, the information can be continually updated. Alternatively, the characterization and the usage history can be determined during test, manufacture, setup, or initialization of the solid-state light source, then the stored information can be retrieved when needed. Although the characterization information and usage history can be determined prior to normal usage and stored in a memory, it can be possible to update the characterization information and the usage history during normal usage.

With reference now to FIG. 5b, there is shown a diagram illustrating a detailed view of the processing of samples of the light output of a solid-state light source to characterize and obtain the usage history of the solid-state light source, according to a preferred embodiment of the present invention. The diagram shown in FIG. 5b can be an exemplary implementation of the processing of samples of the emitted radiation from the solid-state light source and the usage history of the solid-state light source 510 (FIG. 5a) to characterize the solid-state light source. The characterization of the solid-state light source can begin with a characterization of the current pulse waveform (block 555). The characterization of the current pulse waveform can involve a determination of the frequency of the current pulses, the magnitude of the pulses, the duty cycle of the current pulse waveform, and so forth. The characterization of the current pulse waveform can be useful in the determination of the operating temperature of the solid-state light source, for example. Since the current pulse waveform is provided by a light driver circuit that can be controlled by a controller of the display system, the characterization of the current pulse waveform may be a relatively simple task since characteristics of the current pulse waveform should be known a priori.

With reference now to FIG. 6a, there is shown a diagram illustrating a space-time diagram of an exemplary current pulse waveform 605; according to a preferred embodiment of the present invention. The exemplary current pulse waveform 605 comprises multiple current pulses, for example, current pulse 610, with each current pulse being made of current pulses of shorter duration, such as short current pulse 615. The magnitude of the short current pulses 615 in the current pulse 610, as well as the number and the frequencies of both the short current pulses 615 and the current pulse 610, can be dependent upon the desired amount of emitted radiation from the solid-state light source and the characterization history.

With reference back to FIG. 5b, the samples of the emitted radiation of the solid-state light source can then be processed to determine the characteristics of the solid-state light source (block 560). According to a preferred embodiment of the present invention, the processing of the samples of the emitted radiation can be performed in conjunction with the characterized current pulse waveform to provide a usage (thermal dynamic) history of the solid-state light source. For example, the samples can be integrated to compute an average power per unit time and/or differentiated to compute a differential power per differential time. The processing of the samples of the emitted radiation of the solid-state light source, such as by integrating and differentiating, can be used to compute a radiation response of the solid-state light source (block 565). For example, the power from the light tap reaching the detector can be integrated over a desired time interval using standard electrical methods which usually entail charging and discharging a storage capacitor synchronized to a system clock. The stored charge is discharged out of the storage capacitor to generate a synchronized signal proportional to the integrated light flux reaching the detector during an interval of time. This signal can be summed electronically over a longer interval to represent an integral of the signal or electronically differentiated.

A curve can be fitted to the samples of the emitted radiation of the solid-state light source. According to a preferred embodiment of the present invention, the curve can be used to describe an envelope for the samples of the emitted radiation of the solid-state light source. The use of the curve to describe the behavior of the solid-state light source can simplify the computations needed in the determining of the current pulse waveform needed to produce a desired light from the solid-state light source. For example, if the desired light does not substantially match a sample of the emitted radiation of the solid-state light source, then an approximation of the current pulse waveform can be computed using the curve. Furthermore, the storage of the curve, typically done by storing a set of coefficients describing the curve can be a storage space efficient way to store the emitted radiation response behavior of a solid-state light source.

The emitted radiation response of currently available solid-state light sources can be approximated with an acceptable degree of accuracy using a curve that is a sum of multiple order exponential terms, such as F(t)=a₀+a₁exp(t)+a₂exp²(t)+ . . . +aₘexp^{m}(t), where the ‘a’ terms are real-valued coefficients and ‘m’ is an integer value. Alternatively, a good approximation of the emitted radiation response can also be achieved as a sum of single order exponential terms, such as F(t)=b₀expⁿ(t)+b₁expⁿ(t)+b₂expⁿ(t)+ . . . +bₘexpⁿ(t), where ‘n’ is an integer value, or as a simple polynomial, such as F(t)=c₀+c₁t+c₂t²+ . . . +cₘt^{m}, where the ‘b’ and the ‘c’ terms are real-valued coefficients. The number of terms in the curve can be dependent upon factors such as desired accuracy, available processing capability, storage space, and so forth.

With reference now to FIG. 6b, there is shown a diagram illustrating a space-time diagram of an exemplary sequence of samples of the emitted radiation 655 of a solid-state light source, wherein the solid-state light source is driven by the current pulse waveform 605 (FIG. 6a), according to a preferred embodiment of the present invention. The exemplary sequence of samples of the emitted radiation 655 comprises pulses, such as pulse 660, that are responsive to the current pulses 610 of the current pulse waveform 605. The pulse 660 comprises samples of the emitted radiation, such as sample 665. An arc 670, which follows the samples of the emitted radiation making up the pulse 660, is a plot of a curve (F(t)) that is fitted to the samples of the emitted radiation.

According to a preferred embodiment of the present invention, rather than sampling the emitted radiation of the solid-state light source and then computing the characterization of the solid-state light source utilizing the current pulse waveform while the solid-state light source is in a normal operating mode, such as when a projection display system is displaying images, it is possible to characterize the solid-state light source during the manufacture of the projection display system and then store the characterization information in a memory that can be accessed while the projection display system is in use. Computing and storing the information in a memory can help to reduce the computational requirements of the projection display system and enable the use of a processing element that is less capable. Alternatively, the sampling, the computing, and the storing can occur during an initial setup or configuration process during the configuration of the projection display system.

In yet another preferred embodiment of the present invention, if the solid-state light sources used in the projection display system have tight performance tolerances and a variance between individual light sources within a single manufacturing run is small, it can be possible to store an exemplary set of characterizations of a typical solid-state light source in the memories of all projection display systems that use the solid-state light sources. This can help to speed manufacture, which can reduce costs for the system manufacturer. System setup and configuration can also be shortened.

With reference now to FIG. 7, there is shown a diagram illustrating a sequence of events 700 in the use of the characterization and usage history of a solid-state light source to provide a current pulse waveform for use in driving the solid-state light source, according to a preferred embodiment of the present invention. The use of the characterization and usage history of the solid-state light source can begin with the receipt of a set of specifications for a light output (radiation output) for the solid-state light source (block 705). The set of specifications may specify details such as wavelength, intensity, duration, on time, off time, and so forth.

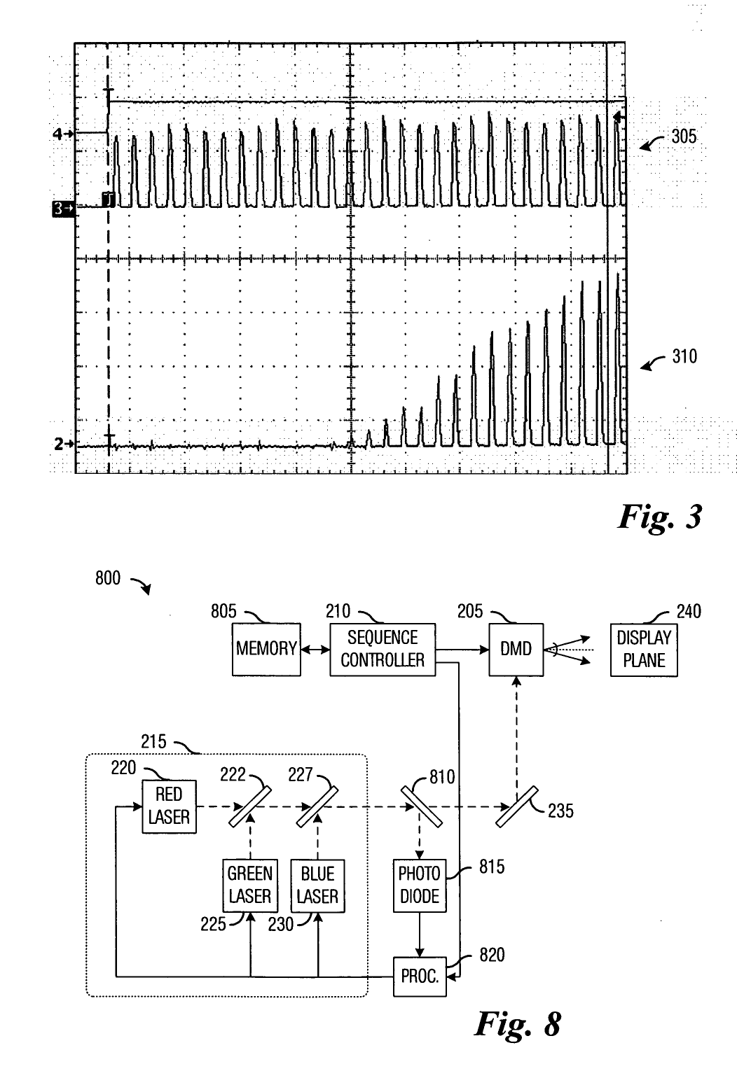

Using the set of specifications along with the characterization of the solid-state light source and the usage history of the solid-state light source, it can be possible to determine a current pulse waveform that can be used to drive the solid-state light source and have the solid-state light source produce a light output that matches (or as closely match as possible) the set of specifications (block 710). For example, based on the present usage history of the solid-state light source, a current pulse waveform can be determined from the characterization of the solid-state light source. If the solid-state light source has been emitting light for a period of time and is at typical operating temperatures and emitting at a steady state, then the current pulse waveform may not need to include a portion to allow the solid-state light source to commence emitting radiation and to reach a steady state (as shown in FIG. 3).

If there is not a match that is sufficiently close to the set of specifications for the light output, interpolation may be needed (block 715), with the interpolation method potentially being dependent upon the granularity of the characterization and the behavior of the solid-state light source. For example, if the light output is in a portion of the light output region of the solid-state light source wherein the light output is relatively constant, then a linear interpolation can be adequate. However, if the light output is in a portion of the light output region of the solid-state light source wherein the light output is changing rapidly, then a higher order interpolation technique should be used. The current pulse waveform can then be used to drive the solid-state light source (block 720) so that the solid-state light source can produce a light output that closely matches the desired light output.

With reference now to FIG. 8, there is shown a diagram illustrating a projection display system 800, wherein a sampling of the light output of a light source is used to adjust a drive current applied to the light source, according to a preferred embodiment of the present invention. The projection display system 800 utilizes an array of micromirror light modulators 205 (also referred to as a DMD) that is controlled by a sequence controller 210 to modulate light from a light source 215. A memory 805 can store image data that is to be loaded into the DMD 205. Individual light modulators in the DMD 205 can reflect light from the light source 215 after it has been directed by a mirror 235 to strike the surface of the DMD 205 either onto a display plane 240 or away from the display plane 240, with the modulation of the light being based on image data of an image being projected. Although the projection display system 800 is shown in FIG. 8 as using a DMD as its light modulator, other microdisplay technologies, such as deformable micromirrors, liquid crystal display, liquid crystal on silicon, and so forth, can be used in place of the DMD 205.

The light source 215 contains individual solid-state light sources. As shown in FIG. 8, the solid-state light sources used in the light source 215 are laser diodes, although light emitting diodes can also be used. The individual solid-state light sources provide narrow-band light at and about the required wavelengths for the projection display system 800, such as a red laser 220, a green laser 225, and a blue laser 230. Before striking the surface of the DMD 205, the light from the light source 215 can be sampled with a light tap 810, with the sampled light being converted into electrical signals by a photo diode 815. A sequence of samples of the light from the light source 215, such as the sequence shown in FIG. 6b, can then be provided to a processor 820 where the sequence of samples can be processed to determine a characterization of the solid-state light sources 220, 225, and 230 in the light source 215. For example, the processor 820 can contain software implementations of the sample processing discussed previously in discussions of FIGS. 5a and 5b. Alternatively, the processor 820 can be replaced by a custom designed integrated circuit containing hardware implementations of the sample processing events discussed above.

The processor 820 can also receive information from the sequence controller 210, which can include sets of specifications for desired light output from the light source 215, for example. The processor 820 can make use of the sets of specifications for the desired light output in combination with the characterization of the solid-state light sources 220, 225, and 230 in the light source 215 and the light source's usage history to determine current pulse waveforms that can be used to drive the solid-state light sources 220, 225, and 230.

In an alternate preferred embodiment of the present invention, the light tap 810, the photo diode 815, and the processor 820 are used during manufacture or during an initial setup and configuration stage to characterize the light source 215. The characterization information can then be stored in the memory 805. In such an embodiment, when the sequence controller 210 desires a specific light output from the light source 215, the sequence controller 210 can determine the needed current pulse waveform by accessing the information stored in the memory 805 and then provide the needed current pulse waveform to the processor 820. The processor 820 can then provide the needed current pulse waveform to the light source 215.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for characterizing a light source, the method comprising:
sampling a light output of the light source;
computing a usage history of the light source; and
processing the samples of the light output in combination with the usage history to characterize the light source.

2. The method of claim 1, wherein the usage history is computed from a drive-current waveform, a heating waveform, or a cooling waveform used to drive the light source, and wherein the usage history indicates an operating temperature of one or more sub-components of the light source.

3. The method of claim 2, wherein the drive-current waveform comprises a sequence of current pulses, and wherein the computing of the usage history comprises calculating an amount of current provided to the light source since a beginning of a present current pulse.

4. The method of claim 1, wherein the sampling comprises:
optically sampling the light output; and
converting the sampled light into an electrical signal.

5. The method of claim 4, wherein the converting is performed by a photo diode, and wherein the sampling is performed by a light tap.

6. The method of claim 1, wherein the processing comprises:
integrating the samples of the light output;
differentiating the samples of the light output; and
computing a light response of the light source based on the integrated samples of light and the differentiated samples of light.

7. The method of claim 6, wherein the computing of the light response comprises:
correcting the integrated samples of light and the differentiated samples of light with respect to the usage history; and
computing a set of coefficients to fit a curve to the corrected samples of the light output.

8. The method of claim 7, wherein the curve comprises an equation selected from the group consisting of: a sum of exponentials of differing order, a sum of single exponentials of a single order, a polynomial, or combinations thereof.

9. A method for driving a light source, the method comprising:
receiving a set of specifications for a desired light output;
using characterization information for the light source to derive a current waveform; and
providing the current waveform to the light source.

10. The method of claim 9 further comprising, after the using, interpolating the characterization information in response to a determination that the characterization information does not substantially match the set of specifications.

11. The method of claim 9, wherein the characterization information is created by:
sampling a light output of the light source;
computing a usage history of the light source; and
processing the samples of the light output in combination with the usage history to characterize the light source.

12. The method of claim 11, wherein the creation of the characterization information occurs during normal operation of a system containing the light source.

13. The method of claim 9, wherein the characterization information is created during the manufacture or the configuration of a system containing the light source and stored in a memory, wherein the using comprises retrieving the characterization information from the memory based on the set of specifications, and wherein the characterization information is updated as new characterization data is gathered during system operation.

14. The method of claim 13, wherein the characterization information is updated as new characterization data is gathered during system operation.

15. A display system comprising:
a solid-state light source for emitting radiation in response to a current waveform provided to the solid-state light source;
an array of light modulators optically coupled to the solid-state light source, the array of light modulators configured to modulate light from the solid-state light source based upon image data to produce images on a display plane;
a sequence controller coupled to the array of light modulators, the sequence controller configured to issue commands to control the operation of the array of light modulators;
an optoelectrical converter optically coupled between the solid-state light source and the array of light modulators, the optoelectrical converter configured to periodically sample light produced by the solid-state light source and convert the samples into electric signals; and
a processor coupled between the optoelectrical converter and the solid-state light source, the processor configured to create a characterization of the solid-state light source utilizing the electrical signals provided by the optoelectrical converter.

16. The display system of claim 15, wherein the processor also utilizes information about the current waveform in characterizing the solid-state light source.

17. The display system of claim 15 further comprising a memory coupled to the sequence controller, the memory configured to store the characterization of the solid-state light source.

18. The display system of claim 17, wherein the sequence controller retrieves from the memory the characterization of the solid-state light source based on a desired light output from the solid-state light source and uses the characterization to determine a current waveform to provide to the solid-state light source.

19. The display system of claim 15, wherein the optoelectrical converter samples a light scattered, reflected, emitted, transmitted, refracted, or diffracted thereof from elements present in the display system.

20. The display system of claim 15, wherein the array of light modulators is a digital micromirror device.
